(19) United States
(12) Patent Application Publication
(10) Pub. No.: US 2026/0212009 A1
(43) Pub. Date: Jul. 23, 2026

(54) SIDE-CHANNEL PROTECTION FOR MACHINE LEARNING MODELS

(71) Applicant: QUALCOMM Incorporated, San Diego, CA (US)

(72) Inventors: Cong CHEN, San Diego, CA (US); Jonathan PETIT, Wenham, MA (US); Jean-Philippe MONTEUUIS, Northborough, MA (US)

(21) Appl. No.: 19/034,433

(22) Filed: Jan. 22, 2025

(51) Int. Cl. G06F 21/55; G06F 9/50

(52) U.S. Cl. CPC G06F 21/554; G06F 9/5077; G06F 2221/034

(57) ABSTRACT

Systems and techniques are described herein for attack mitigation. For instance, a process can include allocating a first masked gadget, of a plurality of masked gadgets, for executing a first machine learning (ML) model; allocating a second masked gadget, of the plurality of masked gadgets, for executing a second ML model; and using the first masked gadget with the first ML model concurrently with the second masked gadget with the second ML model.

### FIELD

The present disclosure generally relates to mitigating attacks for secure computing. For example, aspects of the present disclosure are related to systems and techniques for side channel protection for machine learning (ML) models.

### BACKGROUND

Machine learning (ML) models, such as a neural network (NN) may include multiple layers of interconnected nodes (e.g., neurons). Each node may include various parameters, such as weights and/or bias values, that may be applied to the nodes, along with an activation function to determine whether a node may be used (e.g., activated). These parameters and activation functions may be tuned during training of the ML model to perform various tasks, such as feature/object detection, recognition, etc. In some cases, a ML model may include many millions of nodes along with the associated parameters and activation functions.

In some examples, machine learning models can be implemented using multilayer perceptron (MLP) or other models. A MLP model may include multiple layers of neurons (e.g., nodes, arranged in a structure. The MLP is one of the fundamental building blocks for NN and other ML models. Developing and training a ML model, such as a NN or MLP can be resource intensive, both in terms of computing resources and time.

In some cases, an ML model may be attacked to extract information from the ML model, such as weights, biases, etc., which may be used to reduce an amount of training needed for another ML model. In some cases, an ML model may be attacked using side-channel attacks, such as by monitoring radio frequency emissions of a device executing the ML model. Techniques to prevent such attacks may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for attack mitigation. In one illustrative example, an apparatus for attack mitigation is provided. The apparatus includes: a memory and a processor coupled to the memory. The processor is configured to: allocate a first masked gadget, of a plurality of masked gadgets, for executing a first machine learning (ML) model; allocate a second masked gadget, of the plurality of masked gadgets, for executing a second ML model; and use the first masked gadget with the first ML model concurrently with the second masked gadget with the second ML model.

As another example, a method for attack mitigation is provided. The method includes: allocating a first masked gadget, of a plurality of masked gadgets, for executing a first machine learning (ML) model; allocating a second masked gadget, of the plurality of masked gadgets, for executing a second ML model; and using the first masked gadget with the first ML model concurrently with the second masked gadget with the second ML model.

In another example, a non-transitory computer-readable medium having stored thereon instructions that, when executed by one or more processors, cause the one or more processors to: allocate a first masked gadget, of a plurality of masked gadgets, for executing a first machine learning (ML) model; allocate a second masked gadget, of the plurality of masked gadgets, for executing a second ML model; and use the first masked gadget with the first ML model concurrently with the second masked gadget with the second ML model.

As another example, an apparatus for attack mitigation is provided. The apparatus includes: means for allocating a first masked gadget, of a plurality of masked gadgets, for executing a first machine learning (ML) model; means for allocating a second masked gadget, of the plurality of masked gadgets, for executing a second ML model; and means for using the first masked gadget with the first ML model concurrently with the second masked gadget with the second ML model.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SOC), in accordance with aspects of the present disclosure;

FIG. 2A illustrates an example of a fully connected neural network, in accordance with aspects of the present disclosure;

FIG. 2B illustrates an example of a locally connected neural network, in accordance with aspects of the present disclosure;

FIG. 2C illustrates an example of a convolutional neural network (CNN), in accordance with aspects of the present disclosure;

FIG. 2D illustrates a detailed example of a deep convolutional network (DCN), in accordance with aspects of the present disclosure;

FIG. 3 is a block diagram illustrating an example of a deep convolutional network, in accordance with aspects of the present disclosure;

FIG. 4 illustrates an example attack on a ML model, in accordance with aspects of the present disclosure;

FIG. 5 is a block diagram illustrating a technique for side channel protection for ML models, in accordance with aspects of the present disclosure;

FIG. 6 is a block diagram illustrating configurable scheduling of multiple instances of masked gadgets, in accordance with aspects of the present disclosure;

FIG. 7 is a block diagram illustrating hybrid shuffling with masked gadgets, in accordance with aspects of the present disclosure;

FIG. 8 is a flow diagram illustrating an example of a process for attack mitigation, in accordance with aspects of the present disclosure; and

FIG. 9 illustrates an example computing system which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As noted previously, a ML model can be time and resource consuming to train. During inference time, a trained ML model may include parameters, such as trained weights, biases, activation energies, etc. An attacker with physical access to a device executing the trained ML model may be able to use side channel attacks, such as by monitoring radio frequency (RF) emissions and/or power usage of the hardware executing the ML model and sending arbitrary queries to the ML model, to obtain ML model parameters. In some cases, masking operations may be applied to various portions of the ML model to protect operations of the ML model. Masking may attempt to decorrelate the data being processed by the ML model from how the data is processed such that the data values are not directly seen in the RF leakage and/or power consumption information and/or decorrelate the RF leakage/power consumption of operations of the ML model. Examples of masking may include secret sharing, thresholding, domain-oriented masking (DOM), etc. Masking may be performed by masked gadgets, which may be circuits for masking and/or hiding operations of one or more nodes of the ML model. In some cases, using a single masked gadget shared by multiple nodes of a ML model can substantially slow down operations of the ML model.

Systems, apparatuses, electronic devices, methods (also referred to as processes), and computer-readable media (collectively referred to herein as “systems and techniques”) are described herein for techniques for configurable scheduling of multiple instances of masked gadgets. For example, a device may include a plurality of hardware implemented masked gadgets. These masked gadgets may not be associated with any particular ML model. In some cases, a ML model, or a controller for executing the ML model, may request (e.g., via an indication, request message, etc.) one or more masked gadgets to be allocated to the ML model for execution. Based on the received indication (e.g., request) for the masked gadget, a first masked gadget may be allocated for executing the first ML model. In some cases, multiple masked gadgets, of a plurality of masked gadgets, may be allocated for executing the first ML model. In some cases, a number of masked gadgets to allocate to the first ML model may be determined based on a property of the first ML model, such as the size of the first ML model, or resources expected to be consumed by the first ML model. The multiple masked gadgets may execute concurrently.

In some cases, multiple ML models, such as the first ML model and a second ML model (and in some cases a third ML model, fourth ML model, and/or other ML models), may be executing on the device (e.g., executing concurrently). In such cases, the multiple masked gadgets may be allocated among the multiple ML models such that a second masked gadget may be randomly selected and allocated (e.g., randomly allocated) for executing the second ML model. For example, the first masked gadget may be allocated for executing the second ML model after being used to execute the first ML model. Similarly, the second masked gadget may be allocated for executing the first ML model after being used to execute the second ML model.

In some cases, hybrid shuffling of masked gadgets may be applied. For example, nodes, of a set of nodes in a layer of the first ML model, may be randomly grouped into a number of operation groups of a set of operation groups. The number of operation groups may be based on a number of masked gadgets allocated to the first ML model. A first operation group, of the set of operation groups, may be assigned to execute on the first masked gadget, and a second operation group, of the set of operation groups, may be assigned to execute on the second masked gadget. The operations for nodes of the first operation group may be executed on the first masked gadget, and the operations for nodes of the second operation group may be executed on the second masked gadget. In some cases, the operations for nodes within an operation group may be executed in a set order. However, the starting point of the operations, that is, the node with which operations of the operation group starts, may be randomly selected.

Various aspects of the present disclosure will be described with respect to the figures.

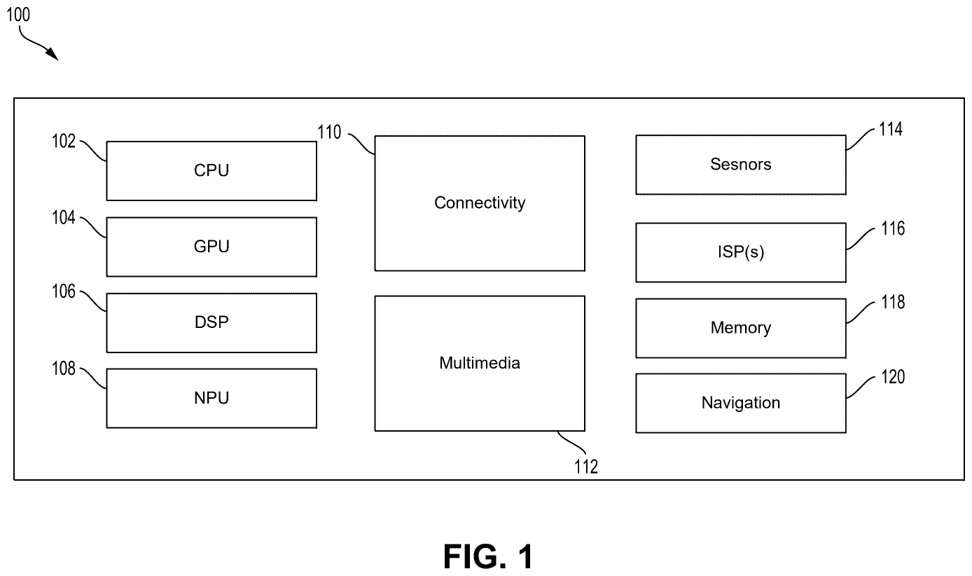

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

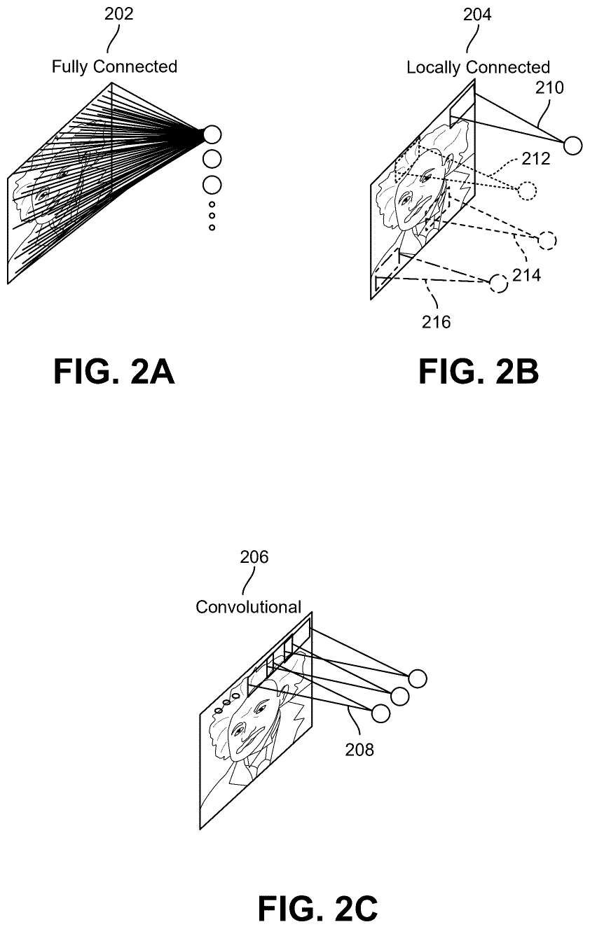

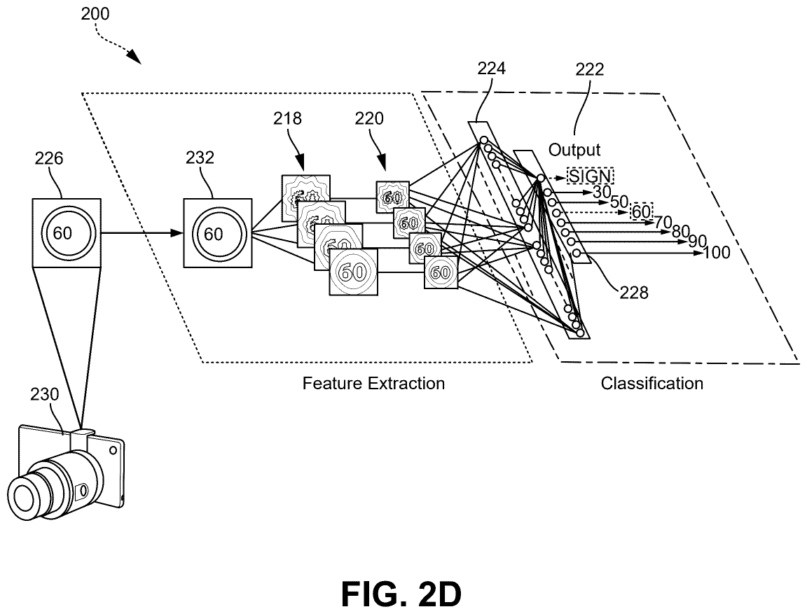

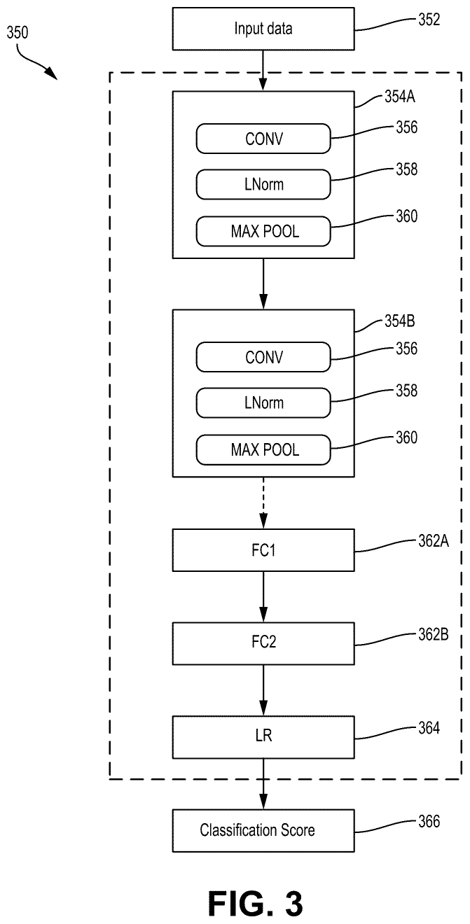

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connect-ed. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decom-pression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as an image capture and processing system based on SOC 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A Softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. Adjusting the weights in such a manner may be referred to as “back propagation” as it involves a “backward pass” through the neural network.

In practice, the error gradient of weights may be calculated over a small number of examples, so that the calculated gradient approximates the true error gradient. The approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and out-put targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

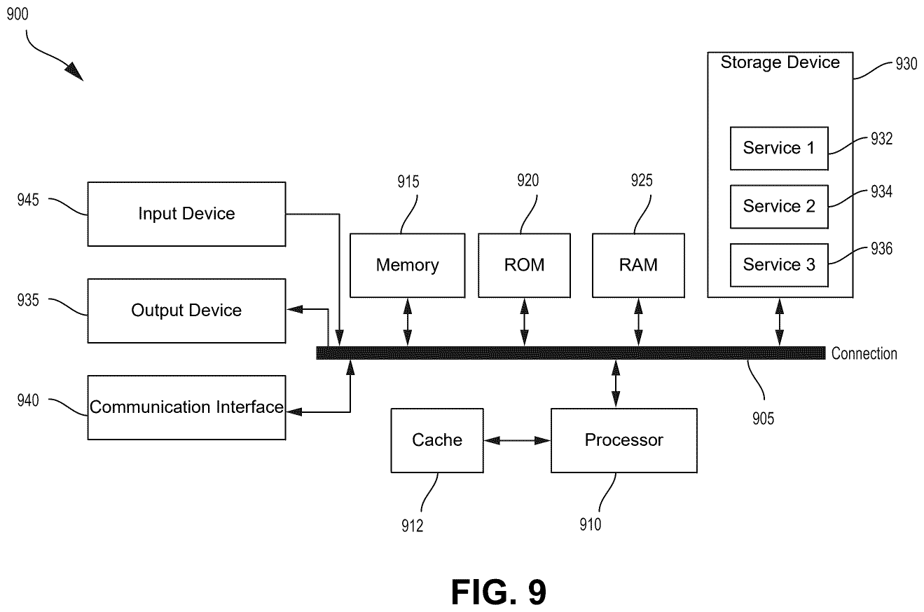

The parallel filter banks, for example, of a deep convolutional network may be loaded on a processor such as a CPU, GPU, NPU, or any other type of processor 910 discussed with respect to the computing system 900 of FIG. 9 to achieve high performance and low power consumption. In alternative aspects, the parallel filter banks may be loaded on a DSP or an ISP of the computing system 900 of FIG. 9. In addition, the deep convolutional network 350 may access other processing blocks that may be present on the computing system 900 of FIG. 9, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. The set of DCNs may function as feature extractors to identify features in an image. In some cases, feature extractors may be used as a backbone for additional ML network components to perform further operations, such as image segmentation.

In some cases, CNN and/or DCNs may be generalized in the form of a transformer network. A transformer network may extract features from an input sequence and the transformer network may include attention mechanisms that may enable the transformer network to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer network may include a series of feedforward layers whose configurations may change in response to identifying non-linear relationships between the input and output sequences, which may also be referred to as a process of “learning” by the layers. The output of a transformer structure may be obtained by applying a linear transformation to the output of a final attention layer. A transformer structure may be of particular use for tasks that involve sequence modeling, text generation, or other like processing.

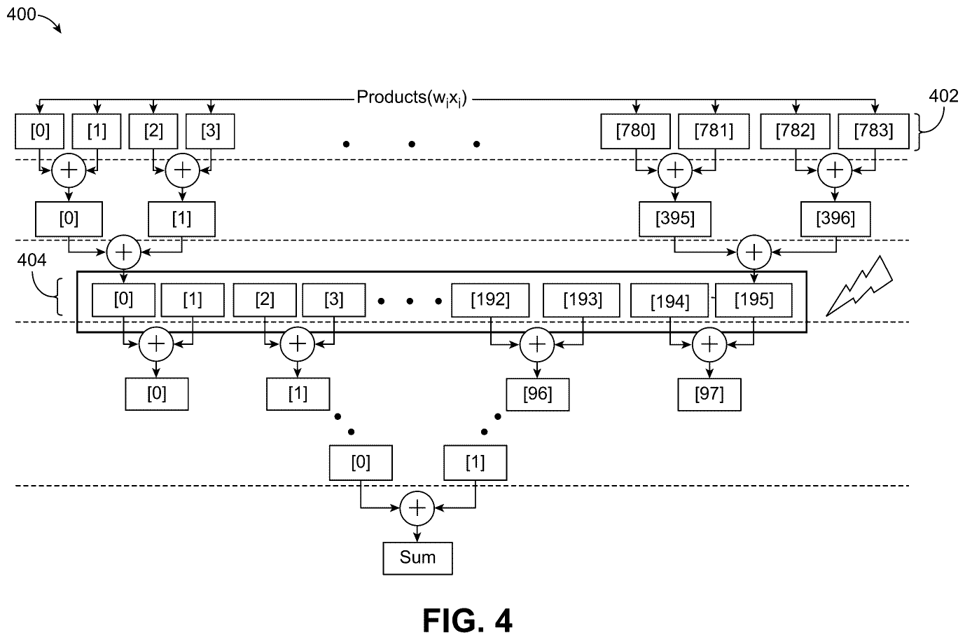

FIG. 4 illustrates an example attack on a ML model 400, in accordance with aspects of the present disclosure. The ML model 400 may be a parallel implementation of an adder tree for a weighted sum for a neuron (e.g., node) where values from 784 input nodes 402 may be connected to a neuron of a hidden layer. For clarity, it may be assumed that each hidden layer of the ML model is comprised of N neurons and that the computation of each neuron is independent of other neurons in the same layer.

In some cases, registers 404 of hardware executing the ML model 400 may be used to store an intermediate weights sum. The intermediate weights sum may be dependent on input values and their corresponding weights. In some cases, an attacker may target the registers 404 in an attempt to recover the weights of the input nodes. The attacker may have physical access to the hardware executing the ML model 400 and may be able to send arbitrary queries to the ML model 400. For example, the ML model 400 may be executing on an IoT device and the attacker may have access to the IoT device. The attacker may collect physical side channel data, such as RF signals leaked, or power consumed, by the hardware while operating and correlate the RF leakage and/or power consumed with the values of the weights. For example, the attacker may capture measurements for a set of queries and align their captured measurements, hypothesize the weights, determine a leakage model for the queries based on the weight hypothesis, calculate how correlated the measurements and leakage model are to determine whether the weight hypothesis is correct.

In some cases, masking may be used to protect a ML model from potential side channel attacks. Masking attempts to decorrelate the data being processed by the ML model from how the data is processed such that the data values are not directly seen in the RF leakage and/or power consumption information. Masking may be performed using multiple techniques such as secret sharing, thresholding, domain oriented masking (DOM), etc. which generally operate by splitting data values (e.g., weights) to be operated on into a random number of shares and/or sets of random values (which combine to form the data value) for processing. With masking, the real value being operated on is hidden using random numbers and the power consumption/RF leakage may correlate with the random values being operated on instead of the read value.

Another technique that may be used to protect a ML model from potential side channel attacks may be hiding. Hiding attempts to decorrelate the RF leakage/power consumption by randomizing the RF leakage/power consumption via noise, shuffling, random delays, equalized leakage, etc. Shuffling may apply a random permutation to N independent operations, for example, to execute the operations in a random order, or shuffling may take an original sequence of N operations and cyclically rotate the operations by a randomly chosen offset. In some cases, the offset may be randomly chosen based on a number obtained from a random number generator and/or pseudorandom number generator. Random delays may randomly introduce delays into the operations, noise injection may inject random operations along with intended operations, and equalized leakage may pre-charge multiple portions of the hardware to skew potential measurements.

These techniques, masking and hiding, may be applied to various portions of the ML model to protect operations of the ML model. For example, masking may be applied to an adder operation, activation function, output logic, etc. of a node. These masked operations for a node in the ML model may then include a masked adder, masked activation function, masked output logic, etc., that may collectively be referred to as “masked gadgets.” A masked gadget may mask (e.g., mask and/or hide) an operation of one or more nodes of a ML model.

In some cases, adding masked gadgets to a ML model can substantially slow down operations of the ML model. For example, the masked gadgets can add one hundred or more clock cycles to an operation for each masked gadget of a node. While some of the clock cycle penalty may be mitigated by adjusting when certain operations of the ML model are performed, adding masked gadgets to the ML model can still lead to a performance penalty. In addition, adding masked gadgets to a ML model, such as for a node of the ML model, can take up a substantial amount of space on a chip.

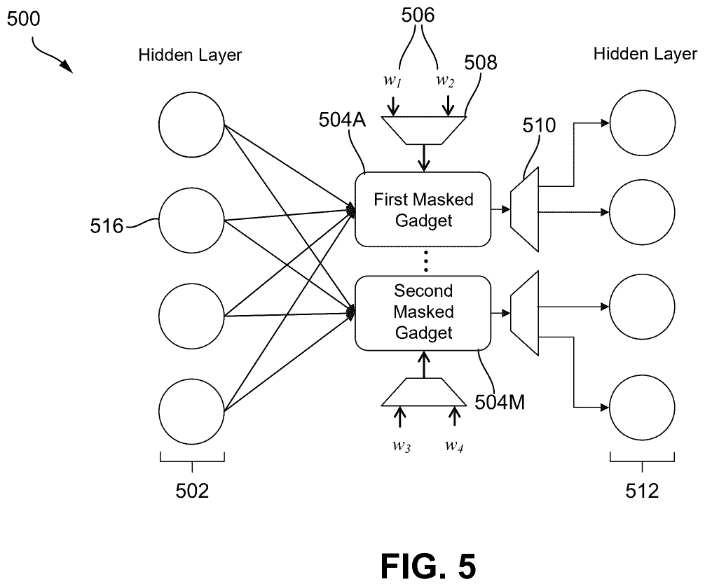

FIG. 5 is a block diagram illustrating a technique for side channel protection for ML models 500, in accordance with aspects of the present disclosure. In some cases, rather than having a single shared masked gadget shared by multiple nodes, which may have a large performance penalty, or using masked gadgets for each node, which may use a substantial amount of space on a chip, a set of M hardware instances of masked gadgets may be implemented for the N nodes of a layer. The N nodes may share the M masked gadgets (e.g., masked gadgets 504A, . . . 504M). For example, output of a first layer of nodes 502 input to a first masked gadget 504A. The first masked gadget 504A may be configured to perform a specific operation, such as performing an addition, determining an activation function, determining an output value, etc. The first masked gadget 504A may receive a vector of weights 506 associated with the first layer and switch 508 from among the received vector of weights 506 based on the node, of the first layer of nodes 502, being processed.

In some cases, output for all of the nodes of the first layer of nodes 502 may be input to the first masked gadget 504, but the first masked gadget 504A may only process the output for some of the nodes (e.g., a first set of nodes) of the first layer of nodes 502. Output of the first masked gadget 504A may be switched 510 (e.g., via a mux) to an appropriate node of a second layer of nodes 512. A second masked gadget 504M may perform similar operations for a second set of nodes of the first layer of nodes 502 to output to appropriate nodes of the second layer of nodes 512. In some cases, using multiple instances (e.g., M instances) of masked gadgets may help improve efficiency from N (where a single masked gadget for all of the nodes is used) to

$$⌈ \frac{N}{M} ⌉ .$$

In some cases, the specific nodes being processed by specific masked gadgets may be randomized. For example, a node 516 of the first layer of nodes 502 may output to both the first masked gadget 504A and the second masked gadget 504M and, during a first run, only the second masked gadget 504M may process the output of the node 516. However, during a second run, the output of the node 516 may be processed on the first masked gadget 504A.

A device may include any number of masked gadgets and multiple types of masked gadget may also be included. In some cases, the ML model 500, or a controller for executing the ML model 500, may request (e.g., via an indication, request message, etc.) one or more masked gadgets to be allocated to the ML model 500 for execution. In some cases, a scheduler may select one or more masked gadgets, from the multiple instances of masked gadgets, for allocation to the ML model 500 based on the request.

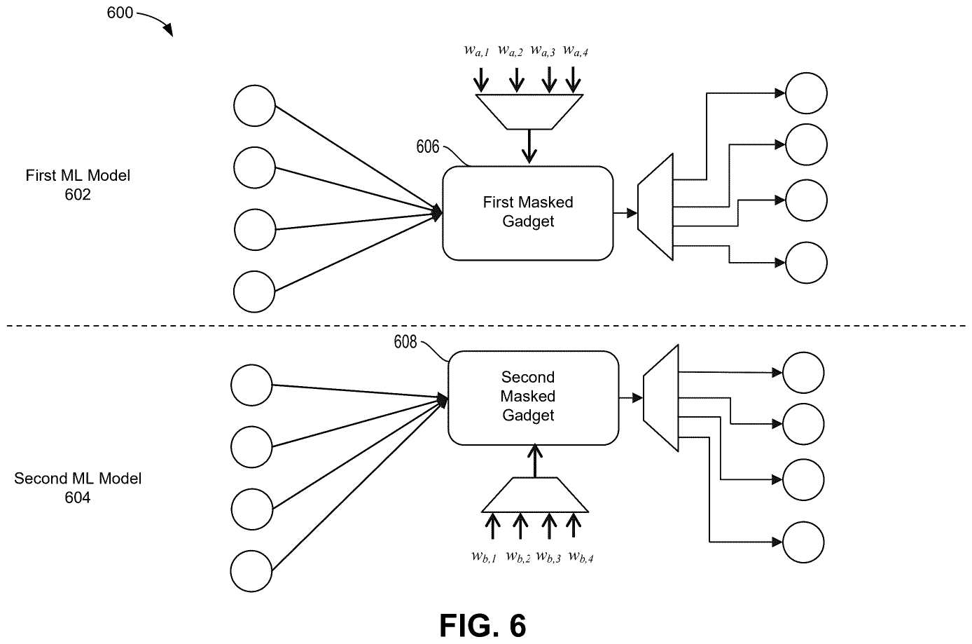

FIG. 6 is a block diagram illustrating configurable scheduling of multiple instances 600 of masked gadgets, in accordance with aspects of the present disclosure. Multiple instances of masked gadgets may allow for configurable scheduling of masked gadgets. For example, the M hardware instances of masked gadgets may be pooled and dynamically assigned to be used by ML models. As an example, where multiple ML models, such as ML model 1 602 and ML model 604, are being executed on a device concurrently, the multiple instances of masked gadgets, such as a first masked gadget 606 and second masked gadget 608, may be dynamically allocated to the executing ML models. While two masked gadgets are shown in FIG. 6, any number of masked objects may be included in a device and any number of masked objects may be allocated to an executing ML model.

In some cases, the number of masked gadgets may be allocated to an ML model of a set of ML models being executed based on properties of and/or resources expected to be consumed by the ML model. In some cases, an ML model that may be run may be profiled to determine what resources are likely to be consumed by the ML model and the number of masked gadgets may be allocated to the ML model based on a profile associated with the ML model. In some cases, the number of masked gadgets allocated to the ML model may be based on a size of the ML model. For example, more masked gadgets may be assigned to a larger ML model (e.g., based on number of nodes, nodes of a certain type, number of layers, number of nodes in a certain layer, overall in memory size, etc.) as compared to a smaller ML model. In some cases, the masked gadgets may be assigned to help maximize the performance of certain ML models and/or balance performance across multiple ML models.

In some cases, a number (and/or type) of (e.g., minimum, optimum, maximum, etc.) masked gadgets that may be used by the ML model may be indicated (e.g., by the ML model, by a predetermined list, etc.). For example, where a certain set of ML models are expected to be executed on a device, a database may include an indication of the number of masked gadgets that may be allocated to the different ML models under various conditions, such as what other ML models are executing, how long a run on a particular ML model is taking, etc. In some cases, the device (e.g., a scheduler for the masked gadgets) may assign (e.g., allocate) masked gadgets to the ML models based on the indicated number(s).

The masked gadgets may be randomly allocated to different ML models. For example, the second masked gadget 608 may be allocated to be used with the second ML model 604 in one run and the second masked gadget 608 may be allocated to be used with the first ML model 602 in another run. Randomly allocating the masked gadgets may improve resistance to side-channel attacks as it is difficult to know to which ML model a particular masked gadget is being used with at inference time. In cases where not all masked gadgets are being used (e.g., non-allocated and/or allocated, but not currently processing data), dummy data may be passed into any unused masked gadgets for processing to help hide which masked gadgets are actually being used.

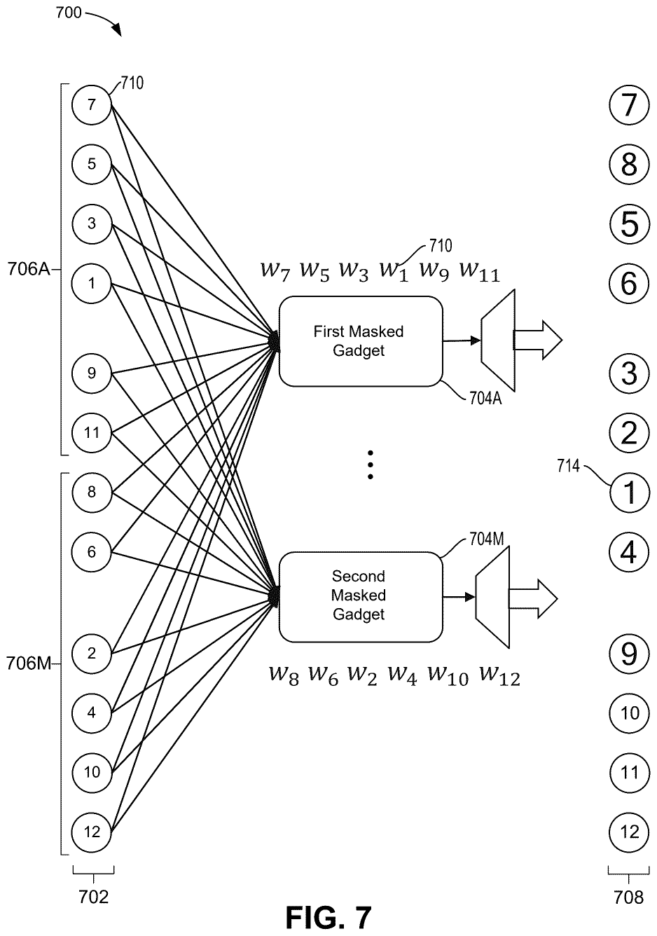

FIG. 7 is a block diagram illustrating hybrid shuffling 700 with masked gadgets, in accordance with aspects of the present disclosure. In FIG. 7, a layer 702 in a ML model may include N nodes and there may be M masked gadgets 704A, . . . 704M (collectively masked gadgets 704). The N nodes of the layer 702 may be parallel nodes that are independent of other nodes within the layer 702. The N nodes of the layer 702 may be randomly divided into M operation groups 706A, . . . 706M (collectively operation groups 706). For example, an indication of the nodes of a layer of the ML model, such as a list of the nodes, may be received, and the nodes of the layer may be randomly divided into operation groups such that a first node 710 of the N nodes of the layer 702 may be randomly grouped into any of the M operation groups 706, resulting in N! possible permutations of the groupings.

Operations for nodes of an operations group, such as a first operation group 706A, may be assigned to execute on one of the masked gadgets 704, such a first masked gadget 704A, to generate outputs 708 corresponding to the nodes of that operations group (e.g., the first operation group 706A). For example, operations for a first node 710 of the layer 702 may be executed by the first masked gadget 704A based on a vector of weights 712 for that first node 710 to determine an output value 714 corresponding to that first node 710.

In some cases, the operation groups 706 may be randomly processed by the masked gadgets 704, while nodes within an operation group may be processed in order on the masked gadgets 704. For example, the execution order of the operation groups 706 may be random, while nodes within a given operation group may execute in a particular order.

In some cases, operations for nodes of a first operation group 706A may be executed randomly, or based on a pattern, across the masked gadgets 704 allocated for the ML model. In some cases, an order in which nodes, of the nodes within an operation group, are executed may also be randomly selected or a starting node, of the nodes within operation groups 706, may be randomly selected. As an example of the later, if the first operation group 706A includes nodes 7, 5, 3, 1, 9, 11, in that order, instead of starting execution with node 7, a starting node may be randomly chosen as node 9 and the execution order of the nodes of the first operation group in a masked gadget (e.g., first masked gadget 704A) may be 9, 11, 7, 5, 3, 1, which may result in M!*N/M permutations for increased security and may obfuscates the side channel signals from each operation group.

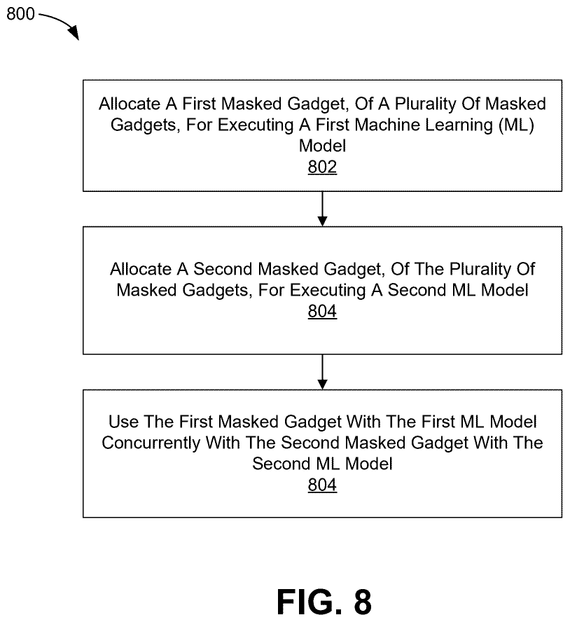

FIG. 8 is a flow diagram illustrating an example of a process 800 for attack mitigation, in accordance with aspects of the present disclosure. The process 800 can be performed by a computing device (e.g., SOC 100 of FIG. 1, computing device or computing system 900 of FIG. 9, etc.) or by a component or system (e.g., the neural networks of FIGS. 2A-2D and FIG. 3, a chipset, one or more processors central processing units (CPUs), digital signal processors (DSPs), graphics processing units (GPUs), any other type of processor(s), any combination thereof, or other component or system) of the computing device. The operations of the process 800 can be implemented as software components that are executed and run on one or more processors (e.g., processor 910 of FIG. 9 or other processor(s)) of the computing device. Further, the transmission and reception of signals by the computing device in the process 800 can be enabled, for example, by one or more antennas and/or one or more transceivers (e.g., wireless transceiver(s)).

At block 802, a computing device (or component thereof) may allocate a first masked gadget (e.g., first masked gadget 504A of FIG. 5, first masked gadget 606 of FIG. 6, first masked gadget 704A of FIG. 7, etc.), of a plurality of masked gadgets (e.g., masked gadgets 504 of FIG. 5, masked gadgets 704 of FIG. 7, etc.), for executing a first machine learning (ML) model (e.g., ML model 500 of FIG. 5, ML model 1 602 of FIG. 6, ML model 604 of FIG. 6, etc.). In some examples, where multiple ML models are being executed on a device concurrently, multiple instances of masked gadgets may be dynamically allocated to the executing ML models. In some cases, the computing device (or component thereof) may determine a number of masked gadgets, of the plurality of masked gadgets, to allocate to the first ML model based on a property of the first ML model or resources expected to be consumed by the first ML model. In some examples, the number of masked gadgets to allocate to the first ML model is determined based on a size of the first ML model. In some cases, the first masked gadget is randomly allocated for executing the first ML model. Randomly allocating the masked gadgets may improve resistance to side-channel attacks as it is difficult to know to which ML model a particular masked gadget is being used with at inference time. In some examples, the masked gadget is configured to mask an operation of an ML model.

At block 804, a computing device (or component thereof) may allocate a second masked gadget (e.g., second masked gadget 504M of FIG. 5, second masked gadget 608 of FIG. 6, second masked gadget 704M of FIG. 7, etc.), of the plurality of masked gadgets, for executing a second ML model (e.g., ML model 604 of FIG. 6). In some cases, the computing device (or component thereof) may allocate the first masked gadget for executing the second ML model after the first masked gadget is used for executing the first ML model. The computing device (or component thereof) may allocate the second masked gadget for executing the first ML model after the second masked gadget is used for executing the second ML model. In some cases, the masked gadgets may perform substantially similar operations and may be interchangeable.

In some examples, the computing device (or component thereof) may randomly group nodes, of a set of nodes of a layer of the first ML model, into a set of operation groups (e.g., operation groups 706 of FIG. 7), execute operations associated with nodes of a first operation group (e.g., operation group 706A of FIG. 7), of the set of operation groups, on the first masked gadget, and execute operations associated with nodes of a second operation group (e.g., operation group 706M of FIG. 7), of the set of operation groups, on a second masked gadget. In some cases, a number of operation groups, in the set of operation groups, is based on a number of masked gadgets allocated to the first ML model. In some examples, the first operation group is assigned to execute on the first masked gadget. In some cases, the second operation group is assigned to execute on the second masked gadget. In some examples, a first starting node of the first operation group for executing on the first masked gadget is randomly selected. In some cases, a second starting node of the second operation group for executing on the second masked gadget is randomly selected. In some examples, an execution order of the set of operation groups is randomly assigned. For example, the operation groups may be randomly processed by the masked gadgets, while nodes within an operation group may be processed in order on the masked gadgets. In some cases, the execution order of the operation groups may be random, while nodes within a given operation group may execute in a particular order.

At block 806, a computing device (or component thereof) may use the first masked gadget with the first ML model concurrently with the second masked gadget with the second ML model.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 800 and/or other processes described herein may include a processor, microprocessor, micro-computer, or other component of a device that is configured to carry out the steps of the process 800 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 800 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 800 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Computing system 900 can be for example any computing device making up SOC 100, fully connected neural network 202, locally connected neural network 204, convolutional neural network 206, deep convolutional network 300, the machine learning (ML) model 400 of FIG. 4, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 900 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 900 also includes a connection 905 that couples various system components including system memory 915, such as read-only memory (ROM) 920 and random-access memory (RAM) 925 to processor 910. Computing system 900 can include a cache 912 of high-speed memory connected directly with, in close proximity to, or integrated as part of processor 910. In some aspects, the processor 910 (in some cases in combination with one or more other components, such as the ROM 920 and/or RAM 925) can perform any of the techniques described herein, such as the techniques described with respect to the machine, and/or the process 800 of FIG. 8.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 can essentially be a completely self-contained computing system, containing multiple cores or processors, a bus, memory controller, cache, etc. A multi-core processor can be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 can also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc. When the code that defines such software is executed by the processor 910, the code causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for attack mitigation, the apparatus comprising: a memory; and a processor coupled to the memory and configured to: allocate a first masked gadget, of a plurality of masked gadgets, for executing a first machine learning (ML) model; allocate a second masked gadget, of the plurality of masked gadgets, for executing a second ML model; and use the first masked gadget with the first ML model concurrently with the second masked gadget with the second ML model.

Aspect 2. The apparatus of Aspect 1, wherein the processor is further configured to: determine a number of masked gadgets, of the plurality of masked gadgets, to allocate to the first ML model based on a property of the first ML model or resources expected to be consumed by the first ML model.

Aspect 3. The apparatus of Aspect 2, wherein the number of masked gadgets to allocate to the first ML model is determined based on a size of the first ML model.

Aspect 4. The apparatus of any of Aspects 1-3, wherein the first masked gadget is randomly allocated for executing the first ML model.

Aspect 5. The apparatus of Aspect 4, wherein the processor is further configured to: allocate the first masked gadget for executing the second ML model after the first masked gadget is used for executing the first ML model; and allocate the second masked gadget for executing the first ML model after the second masked gadget is used for executing the second ML model.

Aspect 6. The apparatus of any of Aspects 1-5, wherein a masked gadget is configured to mask an operation of an ML model.

Aspect 7. The apparatus of any of Aspects 1-6, wherein the processor is further configured to: randomly group nodes, of a set of nodes of a layer of the first ML model, into a set of operation groups, wherein a number of operation groups, in the set of operation groups, is based on a number of masked gadgets allocated to the first ML model; execute operations associated with nodes of a first operation group, of the set of operation groups, on the first masked gadget, wherein the first operation group is assigned to execute on the first masked gadget; and execute operations associated with nodes of a second operation group, of the set of operation groups, on a second masked gadget, wherein the second operation group is assigned to execute on the second masked gadget.

Aspect 8. The apparatus of Aspect 7, wherein a first starting node of the first operation group for executing on the first masked gadget is randomly selected, and wherein a second starting node of the second operation group for executing on the second masked gadget is randomly selected.

Aspect 9. The apparatus of any of Aspects 7-8, wherein an execution order of the set of operation groups is randomly assigned.

Aspect 10. A method for attack mitigation, comprising: allocating a first masked gadget, of a plurality of masked gadgets, for executing a first machine learning (ML) model; allocating a second masked gadget, of the plurality of masked gadgets, for executing a second ML model; and using the first masked gadget with the first ML model concurrently with the second masked gadget with the second ML model.

Aspect 11. The method of Aspect 10, further comprising determining a number of masked gadgets, of the plurality of masked gadgets, to allocate to the first ML model based on a property of the first ML model or resources expected to be consumed by the first ML model.

Aspect 12. The method of Aspect 11, wherein the number of masked gadgets to allocate to the first ML model is determined based on a size of the first ML model.

Aspect 13. The method of any of Aspects 10-12, wherein the first masked gadget is randomly allocated for executing the first ML model.

Aspect 14. The method of Aspect 13, further comprising: allocating the first masked gadget for executing the second ML model after the first masked gadget is used for executing the first ML model; and allocating the second masked gadget for executing the first ML model after the second masked gadget is used for executing the second ML model.

Aspect 15. The method of any of Aspects 10-14, wherein a masked gadget is configured to mask an operation of an ML model.

Aspect 16. The method of any of Aspects 10-15, further comprising: randomly grouping nodes, of a set of nodes of a layer of the first ML model, into a set of operation groups, wherein a number of operation groups, in the set of operation groups, is based on a number of masked gadgets allocated to the first ML model; executing operations associated with nodes of a first operation group, of the set of operation groups, on the first masked gadget, wherein the first operation group is assigned to execute on the first masked gadget; and executing operations associated with nodes of a second operation group, of the set of operation groups, on a second masked gadget, wherein the second operation group is assigned to execute on the second masked gadget.

Aspect 17. The method of Aspect 16, wherein a first starting node of the first operation group for executing on the first masked gadget is randomly selected, and wherein a second starting node of the second operation group for executing on the second masked gadget is randomly selected.

Aspect 18. The method of any of Aspects 16-17, wherein an execution order of the set of operation groups is randomly assigned.

Aspect 19. A non-transitory computer-readable medium having stored thereon instructions that, when executed by one or more processors, cause the one or more processors to: allocate a first masked gadget, of a plurality of masked gadgets, for executing a first machine learning (ML) model; allocate a second masked gadget, of the plurality of masked gadgets, for executing a second ML model; and use the first masked gadget with the first ML model concurrently with the second masked gadget with the second ML model.

Aspect 20. The non-transitory computer-readable medium of Aspect 19, wherein the instructions cause the one or more processors to determine a number of masked gadgets, of the plurality of masked gadgets, to allocate to the first ML model based on a property of the first ML model or resources expected to be consumed by the first ML model.

Aspect 21: A non-transitory computer-readable medium having stored thereon instructions that, when executed by one or more processors, cause the one or more processors to perform operations according to any of Aspects 10 to 18.

Aspect 22: An apparatus for attack mitigation, the apparatus comprising one or more means for performing operations according to any of Aspects 10 to 18.

What is claimed is:

1. An apparatus for attack mitigation, the apparatus comprising:
a memory; and
a processor coupled to the memory and configured to:
allocate a first masked gadget, of a plurality of masked gadgets, for executing a first machine learning (ML) model;
allocate a second masked gadget, of the plurality of masked gadgets, for executing a second ML model; and
use the first masked gadget with the first ML model concurrently with the second masked gadget with the second ML model.

2. The apparatus of claim 1, wherein the processor is further configured to:
determine a number of masked gadgets, of the plurality of masked gadgets, to allocate to the first ML model based on a property of the first ML model or resources expected to be consumed by the first ML model.

3. The apparatus of claim 2, wherein the number of masked gadgets to allocate to the first ML model is determined based on a size of the first ML model.

4. The apparatus of claim 1, wherein the first masked gadget is randomly allocated for executing the first ML model.

5. The apparatus of claim 4, wherein the processor is further configured to:
allocate the first masked gadget for executing the second ML model after the first masked gadget is used for executing the first ML model; and
allocate the second masked gadget for executing the first ML model after the second masked gadget is used for executing the second ML model.

6. The apparatus of claim 1, wherein a masked gadget is configured to mask an operation of an ML model.

7. The apparatus of claim 1, wherein the processor is further configured to:
randomly group nodes, of a set of nodes of a layer of the first ML model, into a set of operation groups, wherein a number of operation groups, in the set of operation groups, is based on a number of masked gadgets allocated to the first ML model;
execute operations associated with nodes of a first operation group, of the set of operation groups, on the first masked gadget, wherein the first operation group is assigned to execute on the first masked gadget; and
execute operations associated with nodes of a second operation group, of the set of operation groups, on a second masked gadget, wherein the second operation group is assigned to execute on the second masked gadget.

8. The apparatus of claim 7, wherein a first starting node of the first operation group for executing on the first masked gadget is randomly selected, and wherein a second starting node of the second operation group for executing on the second masked gadget is randomly selected.

9. The apparatus of claim 7, wherein an execution order of the set of operation groups is randomly assigned.

10. A method for attack mitigation, comprising:
allocating a first masked gadget, of a plurality of masked gadgets, for executing a first machine learning (ML) model;
allocating a second masked gadget, of the plurality of masked gadgets, for executing a second ML model; and
using the first masked gadget with the first ML model concurrently with the second masked gadget with the second ML model.

11. The method of claim 10, further comprising determining a number of masked gadgets, of the plurality of masked gadgets, to allocate to the first ML model based on a property of the first ML model or resources expected to be consumed by the first ML model.

12. The method of claim 11, wherein the number of masked gadgets to allocate to the first ML model is determined based on a size of the first ML model.

13. The method of claim 10, wherein the first masked gadget is randomly allocated for executing the first ML model.

14. The method of claim 13, further comprising:
allocating the first masked gadget for executing the second ML model after the first masked gadget is used for executing the first ML model; and
allocating the second masked gadget for executing the first ML model after the second masked gadget is used for executing the second ML model.

15. The method of claim 10, wherein a masked gadget is configured to mask an operation of an ML model.

16. The method of claim 10, further comprising:
randomly grouping nodes, of a set of nodes of a layer of the first ML model, into a set of operation groups, wherein a number of operation groups, in the set of operation groups, is based on a number of masked gadgets allocated to the first ML model;
executing operations associated with nodes of a first operation group, of the set of operation groups, on the first masked gadget, wherein the first operation group is assigned to execute on the first masked gadget; and
executing operations associated with nodes of a second operation group, of the set of operation groups, on a second masked gadget, wherein the second operation group is assigned to execute on the second masked gadget.

17. The method of claim 16, wherein a first starting node of the first operation group for executing on the first masked gadget is randomly selected, and wherein a second starting node of the second operation group for executing on the second masked gadget is randomly selected.

18. The method of claim 16, wherein an execution order of the set of operation groups is randomly assigned.

19. A non-transitory computer-readable medium having stored thereon instructions that, when executed by one or more processors, cause the one or more processors to:
allocate a first masked gadget, of a plurality of masked gadgets, for executing a first machine learning (ML) model;
allocate a second masked gadget, of the plurality of masked gadgets, for executing a second ML model; and
use the first masked gadget with the first ML model concurrently with the second masked gadget with the second ML model.

20. The non-transitory computer-readable medium of claim 19, wherein the instructions cause the one or more processors to determine a number of masked gadgets, of the plurality of masked gadgets, to allocate to the first ML model based on a property of the first ML model or resources expected to be consumed by the first ML model.
